(19) United States
(12) Patent Application Publication
(10) Pub. No.: US 2014/0324659 A1
(43) Pub. Date: Oct. 30, 2014

(54) Systems and Methods for Highest Payout of Funds Transferred in a Money Transfer Transaction

(71) Applicant: Moneygram International, Inc., Minneapolis, MN (US)

(72) Inventors: Angela Marie Runkle, Maple Grove, MN (US); Lisa Marie Minogue, Forest Lake, MN (US); John Eric Hathaway, Lakeville, MN (US)

(73) Assignee: Moneygram International, Inc., Minneapolis, MN (US)

(21) Appl. No.: 13/874,188

(22) Filed: Apr. 30, 2013

(51) Int. Cl. G06Q 20/10

(52) U.S. Cl. CPC G06Q 20/10; G06Q 40/04
USPC 705/37

(57) ABSTRACT

Systems and methods which provide for the transaction funding amount of a money transfer transaction to be fully paid to a receiving party are provided herein. Embodiments may utilize a central server which compiles and tracks the payment capabilities, exchange rates, and the like, of agents and/or locations in a money transfer network. Such information may be utilized to establish a money transfer transaction. Such a central server may be communicatively connected to agents on one or more of the sending and receiving side of a money transfer transaction and may provide information to one or more agents to assist in completing a transaction.

### TECHNICAL FIELD

The present application relates to money transfer transactions, and more specifically to systems and methods for facilitating money transfer transactions in precise amounts and denominations to provide for maximized payouts of funds.

### BACKGROUND

Generally speaking, money transfers are real-time transactions in that a transaction begins when a sender initiates the transaction at the time the money is to be sent to a receiving party. For example, a money transfer may be utilized in an emergency setting such as when a receiving party has an immediate need for funds. In such a transaction, a sender initiates a money transfer transaction with a money transfer service, such as with a local agent located within a MoneyGram® location. When the transaction information is gathered and the structure of the transaction is finalized, the sender provides the funds to a money transfer agent at or before the time that the funds of the transaction are actually transferred.

Once the funds are received at the time of the transaction, the agent may then provide a transaction code or some other form of transaction identifier to the sender. The sender will then provide the transaction code or identifier to the receiver. With this code the receiver may enter an agent location and complete the transaction and receive the transferred funds.

For a money transfer service, conducting a money transfer transaction efficiently is a primary concern. Inefficiency in a money transfer transaction causes additional administrative cost and potentially causes customer dissatisfaction. Currently when conducting a money transfer transaction, discrepancies may exist between transferred amounts and payment amounts. For example, a sending party may send an amount to a foreign country which will pay out in a foreign currency. However, the exchange rate and/or the denomination amounts available at the receiving money transfer agent may not be configured to pay out the full amount of the transaction. When this occurs, the money transfer service may attempt to fund the receive transaction in multiple currency types, refund the unpaid amount to the sending party or in some cases may retain the remaining amount. Each of these scenarios may cause problems for the money transfer service and/or transacting parties, e.g. may force an additional transaction to be implemented and may potentially cause dissatisfaction in service as a customer's funds are retained.

### BRIEF SUMMARY

The present application provides for systems and methods which provide for the transaction funding amount of a money transfer transaction to be fully paid to a receiving party. Embodiments may utilize a central server which compiles and tracks the payment capabilities, exchange rates, and the like, of agents and/or locations in a money transfer network. Such information may be utilized to establish a money transfer transaction. Such a central server may be communicatively connected to agents on one or more of the sending and receiving side of a money transfer transaction and may provide information to one or more agents to assist in completing a transaction.

For example, in one embodiment, a sending party may establish a money transfer transaction for a specified amount to be sent to a receiving party where the funds are received at a receiving agent location (and in some cases a specified location). A central server may receive one or more transaction details, e.g. a specified transaction amount, and make a determination of one or more amounts which may be sent to the specified location in order to insure that the full send amount may be transferred. The central server may provide feedback to the sending party and indicate a one or more specific amounts that may be transferred in a manner that causes the full amount of the transaction funds to be sent. More specifically, embodiments may provide a first transaction amount corresponding to a first currency type or denomination and determine an amount that may be paid in a second currency type or second denomination by the receiving agent and then provide one or more modified transaction amounts in the first currency to a sending party where the modified amount reflects an amount that will provide for a maximized payout on the receiving end.

Differing currency types may be a result of different currencies found in different countries between the sending party and receiving party. Further, different denominations may be present between sending/receiving parties which reflect different types of fractional currency (e.g. quarter, half, cent, etc.). Embodiments may take into account one or more of these differences when calculating a maximized transfer amount.

In another embodiment a transaction amount may be sent to a receiving agent where the agent does not have the ability to pay a maximized amount for the transferred funds, e.g. due to not having correct denominations of money, differing currencies, etc. Such embodiments may provide for the agent to complete the money transfer transaction and then create a second transaction with the funds from the completed money transfer transaction which converts the funds to an amount that the receiving agent can fund to the receiving party.

In accordance with one embodiment a method for facilitating a money transfer transaction may be provided. The method may include compiling, by a processing device, information regarding a plurality of agent devices corresponding to the abilities of such agents to provide payment of funds sent by a sending party. The information may include at least one of currency type available to the agents and the denomination capabilities of the agents. The method may further include receiving details regarding a money transfer transaction from an agent device of a sending party which include a send amount and a destination for the transaction funds. Additionally, the method may include determining a new send amount to be used to fund the transaction, where the new send amount corresponds to an amount that aligns with an amount of funds that may be paid by a receiving agent. This determining may be made using the compiled information. Further, the method may include providing the new send amount to the agent device of the sending party.

In another embodiment, a method for facilitating a money transfer transaction may include: receiving details corresponding to a money transfer transaction at a sending agent device; sending one or more received details to a central server, where the central server configured to receive information regarding a particular transaction amount and destination and to calculate an appropriate funding amount for the money transfer transaction which provides for a maximum amount of the funds to be distributed by a receiving agent. The method may further include receiving the calculated appropriate funding amount for the money transfer transaction at the agent device; and collecting funds for the money transfer transaction at the agent device.

In yet another embodiment, a computer program product may include code which may be executed and cause a device to receive details corresponding to a money transfer transaction at a sending agent device; send one or more received details to a central server, the central server configured to receive information regarding a particular transaction amount and destination and to calculate an appropriate funding amount for the money transfer transaction which provides for a maximum amount of the funds to be distributed by a receiving agent; receive the calculated appropriate funding amount for the money transfer transaction at the agent device; and collect funds for the money transfer transaction at the agent device.

In another embodiment, an apparatus may include one or more processors configured to receive details corresponding to a money transfer transaction at a sending agent device; send one or more received details to a central server, the central server configured to receive information regarding a particular transaction amount and destination and to calculate an appropriate funding amount for the money transfer transaction which provides for a maximum amount of the funds to be distributed by a receiving agent; receive the calculated appropriate funding amount for the money transfer transaction at the agent device; and collect funds for the money transfer transaction at the agent device.

Further, in one embodiment a method may be provided which includes initializing, by a receiving agent device, a receive transaction for a receiving party; determining whether the agent is able to provide the amount of funds specified by a sending party of the money transfer transaction; and in the event that the agent is not able to provide the specified amount, receiving by the agent device, the transaction funds, and establishing, by the agent device, an exchange transaction which exchanges the amount of the received funds for an amount of funds that can be provided by the receiving agent.

The foregoing has outlined rather broadly the features and technical advantages of the present invention in order that the detailed description that follows may be better understood. Additional features and advantages will be described hereinafter which form the subject of the claims. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of embodiments described herein, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present embodiments.

### BRIEF DESCRIPTION OF THE DRAWINGS

For a more complete understanding, reference is now made to the following descriptions taken in conjunction with the accompanying drawings, in which:

FIG. 1 illustrates a financial transaction computing network in accordance with an embodiment of the present application;

FIG. 2 illustrates a functional block diagram for a money transfer system in accordance with an embodiment of the present application;

FIG. 3 illustrates a method for performing a financial transaction in accordance with an embodiment of the present application;

FIG. 4 illustrates an method for performing a financial transaction in accordance with another embodiment of the present application; and

FIG. 5 illustrates a method for performing a financial transaction in accordance with an embodiment of the present application.

### DETAILED DESCRIPTION

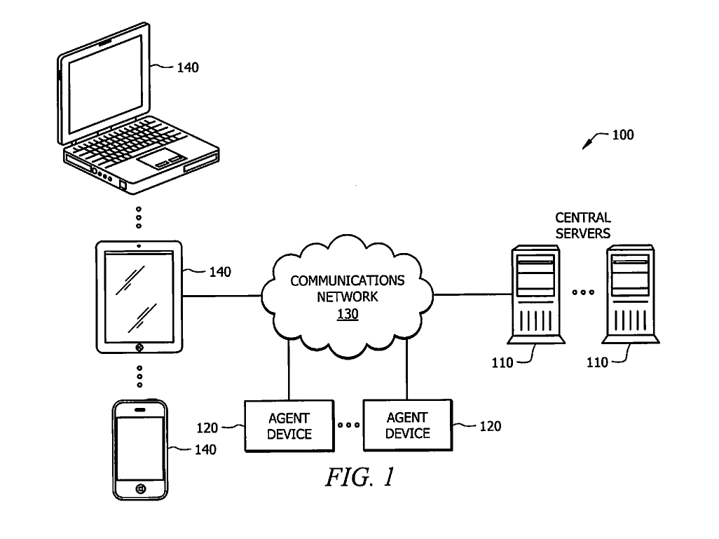

FIG. 1 illustrates a financial transaction computing network 100 in accordance with an embodiment of the present application. Financial transaction computing network 100 may include one or more central servers 110. Central servers 110 correspond to a central or parent entity which administers money transfer transactions between agent devices 120. Central servers 110 may be commonly located or distributed geographically. Additionally, the administration of a money transfer transaction and/or the configuration of one or more agent devices 120 may be implemented by a single server, or by using multiple processing resources of a plurality of servers.

Financial transaction computing network 100 further includes a communication network 130. Communication network 130 may include any type of network which allows for communication between central servers 110 and agent devices 120. For example, communication network 130 may comprise the Internet, WiFi, mobile communications networks such as GSM, CDMA, 3G/4G, WiMax, LTE, and the like. Further, communications network 130 may comprise a combination of network types working collectively.

Agent devices 120 correspond to one or more computing devices which are disposed at an agent location of a money transfer service. Such computing devices are configured with sufficient processing resources, memory, communications capabilities, and the like, to implement the functionality described herein. It is noted that in some embodiments an agent may have multiple devices at a particular location. Further, while only a small number of agent devices 120 are shown for the sake of simplicity, it is contemplated that financial transaction computing network 100 may include a very large number of agent devices 120 which are located worldwide. In some instances, multiple agent devices 120 may correspond to a particular chain of locations owned by an agent, while in other instances, an agent may have only a single location.

In some instances, particular groupings of agent devices 120 may be administered to by a pre-determined central server 110. Such a relationship may be established based on physical proximity of the devices and/or based on capabilities of the devices, e.g. processing resources, bandwidth availability, and the like. In other instances agent devices 120 may be administered to by a central server 110 based on other considerations, such as communication availability, processing resources, etc.

Central server 110 may be configured to compile information from one or more agent devices 120 relating to the financial capabilities of the agent devices. For example, central server 110 may compile information regarding the types of currencies available at an agent device 120. It is appreciated that many money transfer agent locations may have the capability of transacting funds in one or more currencies (e.g. the U.S. dollar and Euro). Particular agent locations may also have varying abilities to distribute funds in certain denominations (e.g. ranging from a 1/100 amount to a whole amount). For example, an agent location may not have certain denominations of change, or such a denomination may not exist (e.g. in the case of the Japanese Yen which requires whole amounts or the West African Franc that may be distributed in multiples of 25's). It is noted that such denomination differences may be a result of the underlying currency, or may be a result of the preferences of the particular agent. In any event, central server 110 may compile and utilize such information.

Central server 110 may compile such information for use in determining a send amount which can be converted to a particular currency and paid out to a receiving party without requiring a refund to a sending party or the otherwise loss of funds. Such a send amount may be selected in response to receiving a desired send amount. For example, a sending party may request a transaction to send $300 USD to a receiving location which utilizes Euros and only pays out in whole Euro amounts. Central server 110 may utilize the information regarding the receiving agent and notify the sending agent or sending party that an amount of $298.84 USD will translate to an even 230 Euros. Central server 110 may also provide a plurality of amounts, e.g. central server 110 may inform the sending agent that an amount of $300.14 will provide for a 231 Euro payout.

In some embodiments, central server 110 may provide such information regarding a particular receiving agent. In yet other embodiments, the particular receiving agent may not be known. For example, if a sending party is sending funds to a receiving party in France, it may not be known which particular agent will be utilized to receive the funds. In this case, central server 110 may be configured to provide an amount which reflects the most common capabilities, such as if the local agents more commonly have particular denomination restrictions. In another example, in some locations, multiple currency types may be generally available at receiving agents. Central server 110 may also be configured to handle amounts which may be paid out whether paying in a first or second currency type. Further embodiments may compensate for each of these issues in combination.

It is noted that the information compiled by server 110 may dynamically change during use of system 100. For example, currency exchange rates may change throughout a particular business day as can capabilities of an agent. Information regarding such changes may be compiled from agent devices, from other sources (e.g. sources which provide financial market information), or a combination of both. In some embodiments, a transaction may be already staged when such changes occur. This may occur in examples where the sending party has had a delay between creating the transaction and completing the funding of the transaction. Such a delay may come from a delay at a particular agent, in instances where the transaction was initially staged by a user on a user device (e.g. a computer, smartphone app, etc.). In these embodiments, an agent device may provide a new amount required to fund the transaction which reflects the changes in the circumstances of the transaction.

It is further noted that embodiments may be configured to calculate an appropriate maximum send amount based on a gross payout amount at the receiving agent. In other embodiments, the payout amount may be calculated based on a net payout amount after one or more government taxes, transaction fees, etc. Such configurations may vary between multiple agent locations in circumstances where taxes/fees may be different.

Because different agents 120 may have different capabilities with respect to available currencies, denomination amounts, etc., in some embodiments, a money transfer transaction may be directed to a particular agent or a particular group of agents. Such embodiments may be utilized in order to provide more certainty with respect to the payment amounts to a receiving party.

In yet another embodiment, central server 110 may receive a send amount from a sending party and upon finding that the send amount will not yield a precise payment amount on the receiving side of the transaction, central server 110 may adjust one or more of a currency exchange amount or a transaction fee to cause the transaction to pay an amount on the receiving end which the agent is capable, while still utilizing the initial send amount.

Network 100 may also include one or more user devices 140. User devices 140 may be any type of device which would facilitate the exchange of information within system 100. For example, user devices 140 may include computer systems, tablet devices, mobile telephones, and the like. Different embodiments may utilize different aspects of the types of client devices. For example, mobile telephones and tablet devices may have the ability to connect with various communications networks and may have different application execution capabilities. User devices 140 may be utilized before, during and after a money transfer transaction in any manner to facilitate convenient and secure transactions.

For example, a sending party may initiate a money transfer transaction from a user device 140 via an online connection or a dedicated application. The user device may communicate with one or more of central server 110 or an agent device 120 to initiate a transaction for a pre-specified amount and may receive a recalculated amount which reflects an amount that may be paid out by a receiving agent. The send transaction may be completed using user device 140 (similar to how an agent device 120 would function), or a transaction may be staged or partly staged at the user device and the details may be later provided to an agent device 120 for completion of the transaction.

On the receiving side, a receiving party using user device 140 may be notified of a money transfer transaction via an online application, dedicated application, email, text, etc. Such a communication may direct the receiving party to a receiving agent location where the transferred funds may be paid. In some instances, such a communication may list a plurality of agents which are able to pay the maximized money transfer amount (excluding one or more other agents). In other instances, the communication may notify the receiving party that the maximum amount is not able to be paid out at a particular agent location. Further, the communication may notify the receiving party whether such an agent is able to receive the funds and generate an exchange transaction to provide less than the maximum funds.

In some embodiments, a maximum payout amount may be calculated for a transaction either using the disclosed methods or other manual methods, whereupon when the receiving party enters a receiving agent location, the maximum payout is unavailable due to one or more reasons such as the agent only retains different types of currency, utilizes different denomination values, and the like. In such circumstances, a receiving party may be directed to a different agent location which can facilitate the payout. Such an instruction may be provided in response to utilizing system 100 and polling central server 110 to retrieve agent information corresponding to an agent which is capable of providing the appropriate payout.

In some embodiments, whether utilizing a maximum payout calculation prior to the send transaction, or in the context of a standard money transfer transaction, where a receiving agent is not able to provide payment for the necessary amount, such embodiments may provide for a receiving agent to receive the funds electronically and initiate a separate exchange transaction. For example, the receiving agent may receive the full amount of the funds into the receiving agent's accounting and/or paid out in a voucher, whereupon the agent may initiate the exchange transaction to exchange the received funds into a different currency or denomination for a fee. The fee may be greater or equal to the difference in the maximum payment amount and the amount that the agent is able to pay out in funds.

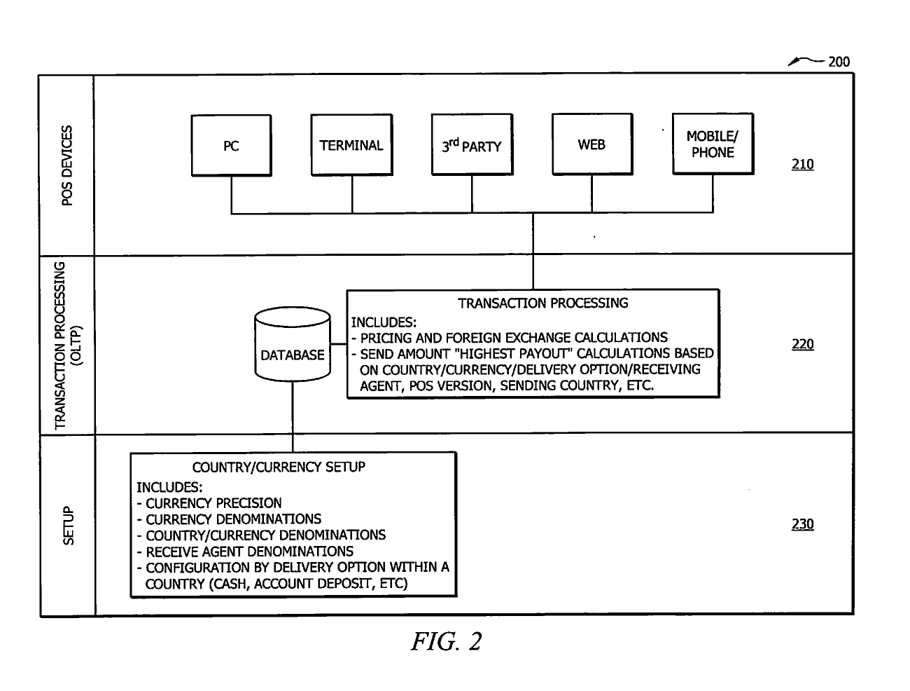

FIG. 2 illustrates a functional block diagram 200 for a money transfer system in accordance with an embodiment of the present application. Section 210 illustrates Point of Sale (POS) devices which may include computing devices belonging to an agent or a user of a money transfer network. Such a device may be a personal device, agent kiosk/agent computing device, a web interface to an online program, etc. Section 220 includes transaction processing stages. This processing may be handled by one or more devices having processing capabilities (such as the agent devices, central servers, and/or user devices shown in FIG. 1). Such transaction processing may calculate exchanges, process and calculate a send amount to provide a maximum payout based on one or more of country, currency, agent capabilities, etc. Such processing may utilize a database which stores information which is compiled for use in this transaction processing. Section 230 represents a setup portion. In some instances it may be preferable to retain/compile setup information regarding currencies, agent capabilities, etc., and store it in a database for later processing. This initial setup may function to expedite transaction processing as it may obviate the need to communicate with a receiving agent in real time when a transaction is established. It is noted, however, that embodiments may also handle such communications in real time.

In view of exemplary systems shown and described herein, methodologies that may be implemented in accordance with the disclosed subject matter will be better appreciated with reference to various functional block diagrams. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

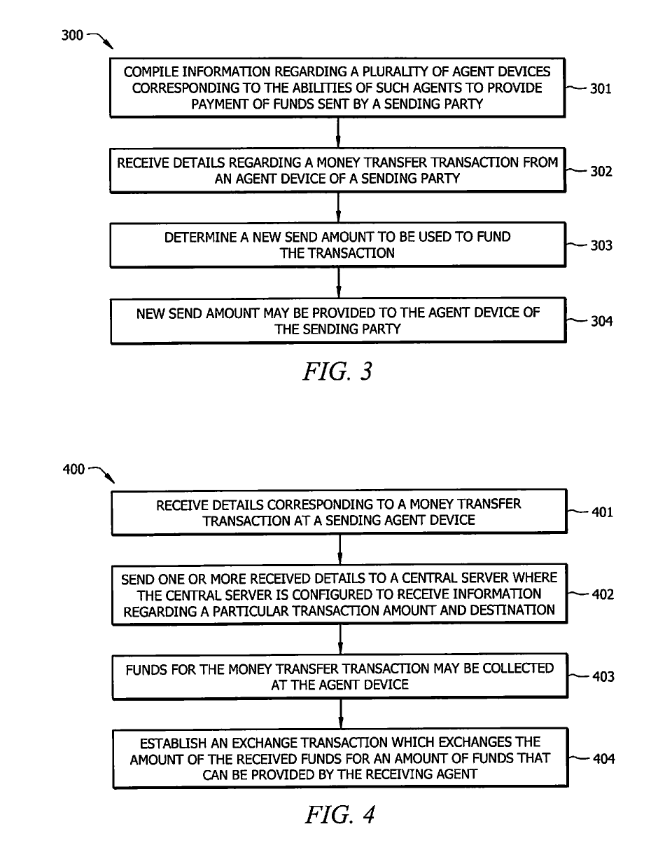

FIG. 3 illustrates a method 300 for performing a financial transaction in accordance with an embodiment of the present application. It is noted that method 300 may be implemented within one or more systems, such as systems 100 and 200 described above. Method 300 includes, at block 301, compiling information regarding a plurality of agent devices corresponding to the abilities of such agents to provide payment of funds sent by a sending party. This information may include at least one of the currency types available to the agents and the denomination capabilities of the agents. Additionally, in some embodiments, such compiling may be implemented by one or more processing devices on a central server.

Method 300 includes, at block 302, receiving details regarding a money transfer transaction from an agent device of a sending party. These details may include a send amount and a destination for the transaction funds. Additionally, method 300 includes, at block 303 determining a new send amount to be used to fund the transaction. The new send amount may correspond to an amount that aligns with a precise amount of funds that may be paid by a receiving agent. This determining is made using the compiled information compiled at block 301. Further, the new send amount may be provided to the agent device of the sending party at 304.

FIG. 4 illustrates a method 400 for performing a financial transaction in accordance with an embodiment of the present application. It is noted that method 400 may be implemented within one or more systems, such as systems 100 and 200 described above. Method 400 may include, at 401, receiving details corresponding to a money transfer transaction at a sending agent device. Additionally, method 400 may include, at 402, sending one or more received details to a central server where the central server is configured to receive information regarding a particular transaction amount and destination. The central server may be further configured to calculate an appropriate funding amount for the money transfer transaction which provides for a maximum amount of the funds to be distributed by a receiving agent.

Method 400 may further include, at block 403, receiving the calculated appropriate funding amount for the money transfer transaction at the agent device. Additionally, the funds for the money transfer transaction may be collected at the agent device at block 404.

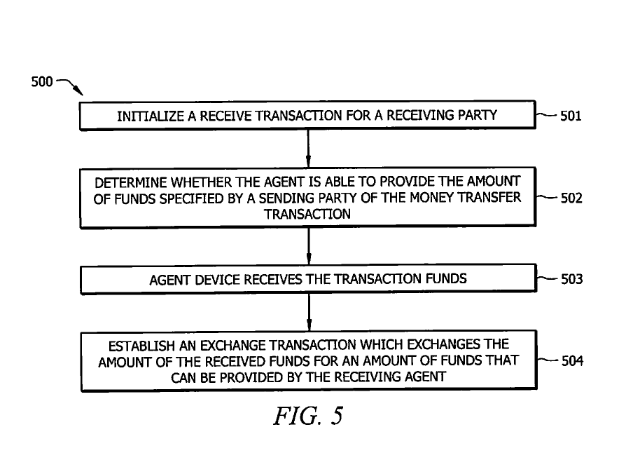

FIG. 5 illustrates a method 500 for performing a financial transaction in accordance with an embodiment of the present application. It is noted that method 500 may be implemented within one or more systems, such as systems 100 and 200 described above. Method 500 may include, at block 501, initializing a receive transaction for a receiving party. Such a receive transaction may be initialized by a processing device located in a receiving agent device. Method 500 may include, at block 502, determining whether the agent is able to provide the amount of funds specified by a sending party of the money transfer transaction. In the event that the agent is not able to provide the specified amount, method 500 may include, at block 503, receiving by the agent device, the transaction funds, and at block 504, establishing an exchange transaction which exchanges the amount of the received funds for an amount of funds that can be provided by the receiving agent.

It is noted that the functional blocks and modules in FIGS. 1-5 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method for facilitating a money transfer transaction, said method comprising:
compiling, by a processing device, information regarding a plurality of agent devices corresponding to the abilities of such agents to provide payment of funds sent by a sending party, said information including at least one of the currency types available to the agents and the denomination capabilities of the agents;
receiving details regarding a money transfer transaction from an agent device of a sending party, said details including a send amount and a destination for the transaction funds;
determining a new send amount to be used to fund the transaction, said new send amount corresponding to an amount that aligns with a precise amount of funds that may be paid by a receiving agent, said determining made using said compiled information; and
providing the new send amount to the agent device of the sending party.

2. The method of claim 1 wherein the precise amount of funds that may be paid by a receiving agent aligns with the amount provided by the sending party.

3. The method of claim 1 further comprising updating the compiled data to reflect changes in one or more of the plurality of agent device's capabilities.

4. The method of claim 1 further comprising updating the compiled data to reflect changes in currency exchange rates.

5. The method of claim 1 wherein the determined send amount corresponds to a recalculated amount from an earlier staged money transfer transaction.

6. A method for facilitating a money transfer transaction, said method comprising:
receiving details corresponding to a money transfer transaction at a sending agent device;
sending one or more received details to a central server, said central server configured to receive information regarding a particular transaction amount and destination and to calculate an appropriate funding amount for the money transfer transaction which provides for a maximum amount of the funds to be distributed by a receiving agent;
receiving the calculated appropriate funding amount for the money transfer transaction at the agent device; and
collecting funds for the money transfer transaction at the agent device.

7. The method of claim 6 wherein the appropriate funding amount corresponds to an exact amount to be provided by the sending party to yield an amount that the receiving agent is able to evenly distribute.

8. The method of claim 6 wherein the central server is configured to compile available currency type data for a plurality of agents.

9. The method of claim 8 wherein at least one of the plurality of agents is configured to transact funds in a plurality of currencies.

10. The method of claim 6 wherein the central server is configured to compile denomination information from a plurality of agents.

11. The method of claim 6 further comprising receiving a recalculating appropriate funding amount which reflects changes that have occurred at one or more agents.

12. The method of claim 6 further comprising:
receiving the transferred funds at a receiving agent device; and
distributing the funds to a receiving party.

13. The method of claim 12 further comprising establishing an exchange transaction which exchanges the amount of the received funds for an amount of funds that can be provided by the receiving agent.

14. A computer program product having a non-transitory computer readable medium with code encoded thereon which, when executed causes one or more processing devices to:
receive details corresponding to a money transfer transaction at a sending agent device;
send one or more received details to a central server, said central server configured to receive information regarding a particular transaction amount and destination and to calculate an appropriate funding amount for the money transfer transaction which provides for a maximum amount of the funds to be distributed by a receiving agent;
receive the calculated appropriate funding amount for the money transfer transaction at the agent device; and
collect funds for the money transfer transaction at the agent device.

15. The computer program product of claim 14 wherein the precise amount of funds that may be paid by a receiving agent aligns with the amount provided by the sending party.

16. The computer program product of claim 14 wherein said code is further configured to cause one or more processing devices to update the compiled data to reflect changes in one or more of the plurality of agent device's capabilities.

17. The computer program product of claim 14 said code is further configured to cause one or more processing devices to update the compiled data to reflect changes in currency exchange rates.

18. The computer program product of claim 14 wherein the determined send amount corresponds to a recalculated amount from an earlier staged money transfer transaction.

19. An apparatus configured for implementing financial transactions, the apparatus comprising:
an agent computer having at least one processor and memory coupled to the at least one processor, wherein the at least one processor is configured to:
receive details corresponding to a money transfer transaction at a sending agent device;
send one or more received details to a central server, said central server configured to receive information regarding a particular transaction amount and destination and to calculate an appropriate funding amount for the money transfer transaction which provides for a maximum amount of the funds to be distributed by a receiving agent;
receive the calculated appropriate funding amount for the money transfer transaction at the agent device; and
collect funds for the money transfer transaction at the agent device.

20. The apparatus of claim 19 wherein the appropriate funding amount corresponds to an exact amount to be provided by the sending party to yield an amount that the receiving agent is able to evenly distribute.

21. The apparatus of claim 19 wherein the central server is configured to compile available currency type data for a plurality of agents.

22. The apparatus of claim 21 wherein at least one of the plurality of agents is configured to transact funds in a plurality of currencies.

23. The apparatus of claim 19 wherein the central server is configured to compile denomination information from a plurality of agents.

24. The apparatus of claim 19 wherein said at least one processor is further configured to receive a recalculating appropriate funding amount which reflects changes that have occurred at one or more agents.

25. The apparatus of claim 19 wherein said at least one processor is further configured to:
receive the transferred funds at a receiving agent device; and
distribute the funds to a receiving party.

26. The apparatus of claim 25 wherein said at least one processor is further configured to establish an exchange transaction which exchanges the amount of the received funds for an amount of funds that can be provided by the receiving agent.

27. A method for facilitating a money transfer transaction, said method comprising:
initializing, by a receiving agent device, a receive transaction for a receiving party;
determining whether the agent is able to provide the amount of funds specified by a sending party of the money transfer transaction; and
in the event that the agent is not able to provide the specified amount,
receiving by the agent device, the transaction funds, and
establishing, by the agent device, an exchange transaction which exchanges the amount of the received funds for an amount of funds that can be provided by the receiving agent.

28. The method of claim 27 wherein the received transaction funds are electronically received.

29. The method of claim 27 wherein the exchange transaction exchanges the received transaction funds for funds of a different currency.

30. The method of claim 27 wherein the exchange transaction exchanges the received transaction funds for funds of a different denomination.
